(19) United States
(12) Patent Application Publication
(10) Pub. No.: US 2004/0117689 A1
(43) Pub. Date: Jun. 17, 2004

(54) Method and system for diagnostic approach for fault isolation at device level on peripheral component interconnect (PCI) bus

(75) Inventors: Richard Edwin Harper, Chapel Hill, NC (US); Tarun Deep Singh, East Lansing, MI (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/317,151

(22) Filed: Dec. 12, 2002

(51) Int. Cl. H04B 1/74

(52) U.S. Cl. 714/43; 714/47

(57) ABSTRACT

A method (and system) monitoring a bus with pair-wise participants, includes detecting a problem during a transaction between first and second participants on the bus, and determining which participant is at fault for the problem or whether the problem includes a systemic bus problem.

### BACKGROUND OF THE INVENTION

1. Field of the Invention

The present invention generally relates to a method and system for diagnosing a fault in hardware, and more particularly to a method and system for diagnosing a fault in a device on a peripheral component interconnect (PCI) bus.

2. Description of the Related Art

Hardware prediction techniques are used for predicting the operation of the hardware. A hardware predictor can be implemented as a finite state machine that outputs a prediction of an unknown value of particular bit(s) given some input bits and its internal state.

The logic used for prediction typically works in two modes. A first mode is called a “prediction mode” (e.g., it accepts an input and produces an output) and the second mode is called an “update mode” (e.g., it accepts an input and updates its past record).

Since mispredictions waste power and cycles, it is desirable to avoid them. To minimize this problem, Alloyed Predictors have been developed. They rely on a global history and a local history for the branch prediction. This helps in reducing the number of mispredictions.

In PCI architecture, either a master or a slave can generate errors. Some of these errors are serious in nature, such as a parity error which may result in the generation of serious interrupts like a nonmaskable interrupt (NMI), further resulting in a shut-down of the system.

There are other signals which can cause generation of an NMI. For example, target aborts during the transaction phase can lead to the generation of an NMI. This creates the need to pinpoint the device which is causing the problems during the transaction phase.

However, prior to the present invention, there was no approach, which could pinpoint a culprit device using Boolean logic based on alloyed prediction, rather than weights based on misprediction. Instead, conventional approaches required history tables or a pattern history table, thereby resulting in increased hardware and system complexity.

Further, in the conventional approaches, the operating system (OS) could not take any necessary actions based on the seriousness of fault.

### SUMMARY OF THE INVENTION

In view of the foregoing and other problems, drawbacks, and disadvantages of the conventional methods and structures, an exemplary purpose of the present invention is to provide a method and structure which can pinpoint a culprit device using Boolean logic based on alloyed prediction.

Another purpose is to provide a method and structure which does not require history tables or a pattern history table, thereby resulting in decreased hardware requirements.

A further purpose is to provide a method and system in which the OS can take any necessary actions based on the seriousness of the fault.

In a first aspect of the present invention, a method (and system) of monitoring a bus with pair-wise participants, includes detecting a problem during a transaction between first and second participants, and determining which participant is at fault for the problem or whether the problem includes a systemic bus problem.

With the unique and unobvious features of the present invention, the culprit device can be pinpointed using Boolean logic based on alloyed prediction rather than weights based on misprediction. Additionally, this approach does not require history tables (such as a pattern history table), thereby resulting in reduced hardware. Additionally, the invention allows the OS to take any necessary actions based on the seriousness of the error.

In the present invention, a monitor-based approach (e.g., for purposes of the present invention, this means the use of an external agent to monitor the operation of a system or subsystem) based on the PCI bus specification is used to detect whether the PCI Bus constraints are obeyed. The monitor is developed preferably using Hardware Descriptive Languages (HDL) to describe appropriate behavior, and is implemented preferably using environments, or agents.

If the constraints under an agent's control are followed, then the agent generates a correct signal, and if it generates a signal that is false, then the PCI Bus constraints have been violated. There are other criteria which a monitor-based approach should fulfill.

That is, the system must return to an idle state, which will help to find deadlock states. Additionally, the termination type should not change during a single transaction which helps in checking if an agent can signal a target abort in one cycle and then return a retry in the next clock cycle before the transaction ends.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates an exemplary, upper level environment 100 in which the present invention is employed;

FIG. 2 illustrates an architecture 200 according to the present invention;

FIG. 3 illustrates a top-level flowchart of a process 300 according to the present invention;

FIG. 4 illustrates a portion (subset) of the architecture 200 of FIG. 2 according to the present invention;

FIG. 5 illustrates an exemplary logic flow 500 for a device pair information register 240 shown in FIG. 2 according to the present invention;

FIG. 6A illustrates a table 600 provided in a global information register 250 shown in FIG. 2 according to the present invention, and more specifically, FIG. 6A shows the possible combinations (e.g., 6) of transactions of three (3) PCI devices 1, 2, and 3 in which the first of these devices is a master and the second device is a slave device;

FIG. 6B illustrates a table 650 showing various combinations of master-slave transactions occurring over a bus;

FIG. 6C illustrates a table in which a fault-checking diagnosis is made based on several transactions, as opposed to a single transaction;

FIG. 7 illustrates a logic flow 700 of transitions between master-slave combinations according to the present invention;

FIG. 8 illustrates a flowchart of a process 800 for a device “1” on the bus according to the present invention;

FIG. 9 illustrates a logic 900 according to the present invention;

FIG. 10 illustrates a logic 1000 according to the present invention;

FIG. 11 illustrates capturing an address of a target device on a bus (e.g., a PCI bus);

FIG. 12 illustrates a flowchart of a process 1200 for determining whether a protocol has been violated according to the present invention;

FIG. 13 illustrates a flowchart of a process 1300 for determining whether another protocol has been violated according to the present invention;

FIG. 14 illustrates a flowchart of a process 1400 used with the method of FIG. 13 according to the present invention;

FIG. 15 illustrates an exemplary hardware/information handling system 1500 for incorporating the present invention therein; and

FIG. 16 illustrates a signal bearing medium 1600 (e.g., storage medium) for storing steps of a program of the method according to the present invention.

### DETAILED DESCRIPTION OF PREFERRED EMBODIMENTS OF THE INVENTION

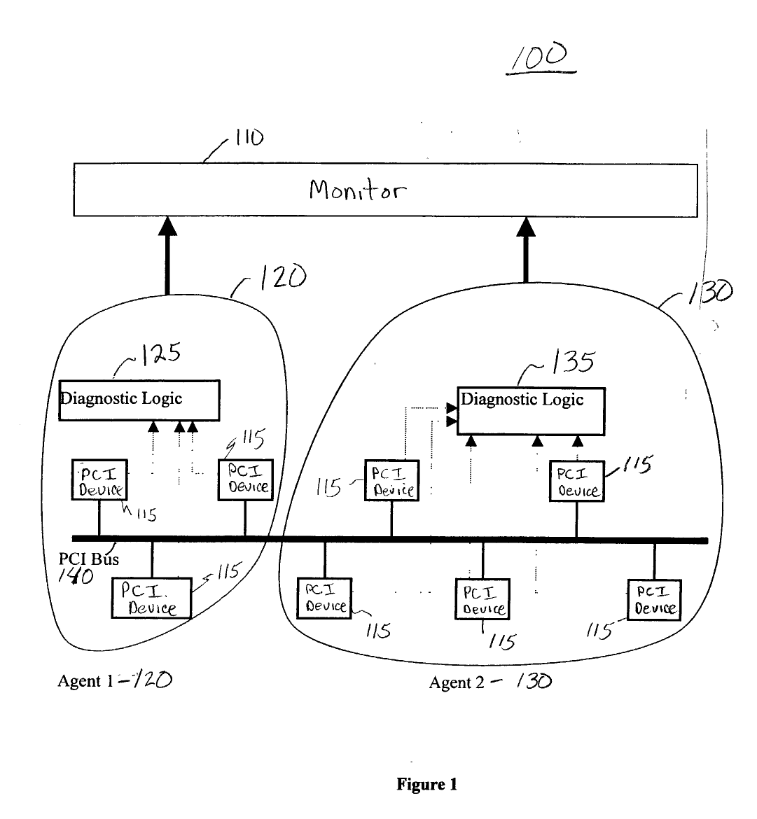

Referring now to the drawings, and more particularly to FIGS. 1-16, there are shown preferred embodiments of the method and structures according to the present invention. It is noted that, for the reader's understanding and clarity, a reference numeral used in a Figure to reference a feature will be used throughout the drawings to illustrate like items.

### PREFERRED EMBODIMENT

FIG. 1 shows a high level architecture 100 of the approach and environment of the present invention, including a monitor 110 and a plurality of agents (e.g., first and second agents) 120, 130 which are linked together via a PCI bus 140. Each of the agents may include one or more PCI devices 115. The two monitor agents 120, 130 have been created to be responsible for checking the PCI constraints to be followed by the devices under their supervision.

A diagnostic logic 125, 135 is present in each environment (e.g., agent 120, 130) and will govern the faulty device in its mode of operation or any other problem related to the bus.

The dashed lines (unreferenced) in FIG. 1 are for GNT signals, DEVSEL signals, bus error signals, PCI Bus protocol signals and the like between the PCI device(s) 115 and the diagnostic logic 125, 135.

Thus, the two monitor agents 120, 130 have been created which will be responsible for checking the PCI constraints to be followed by the devices under their supervision.

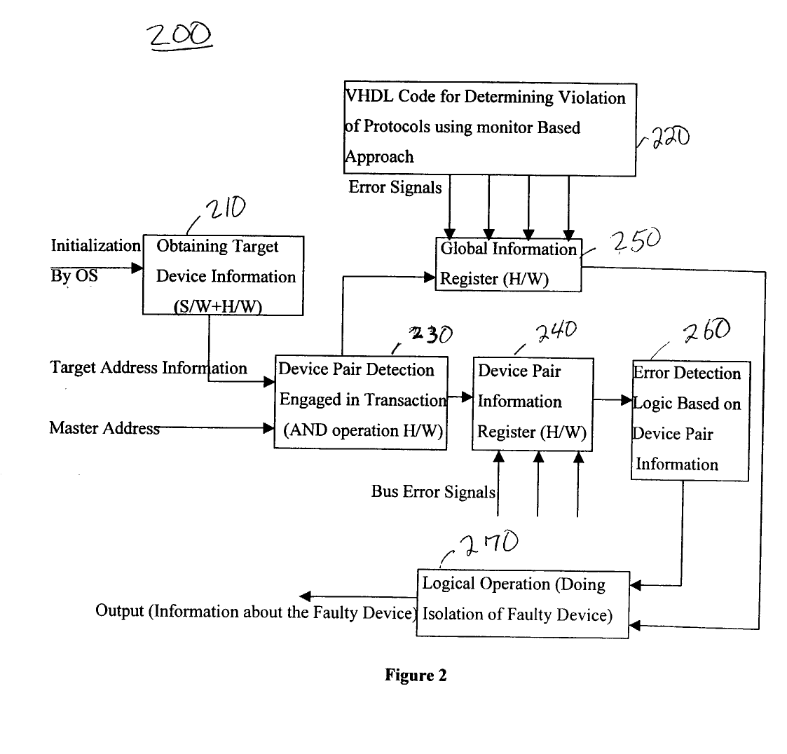

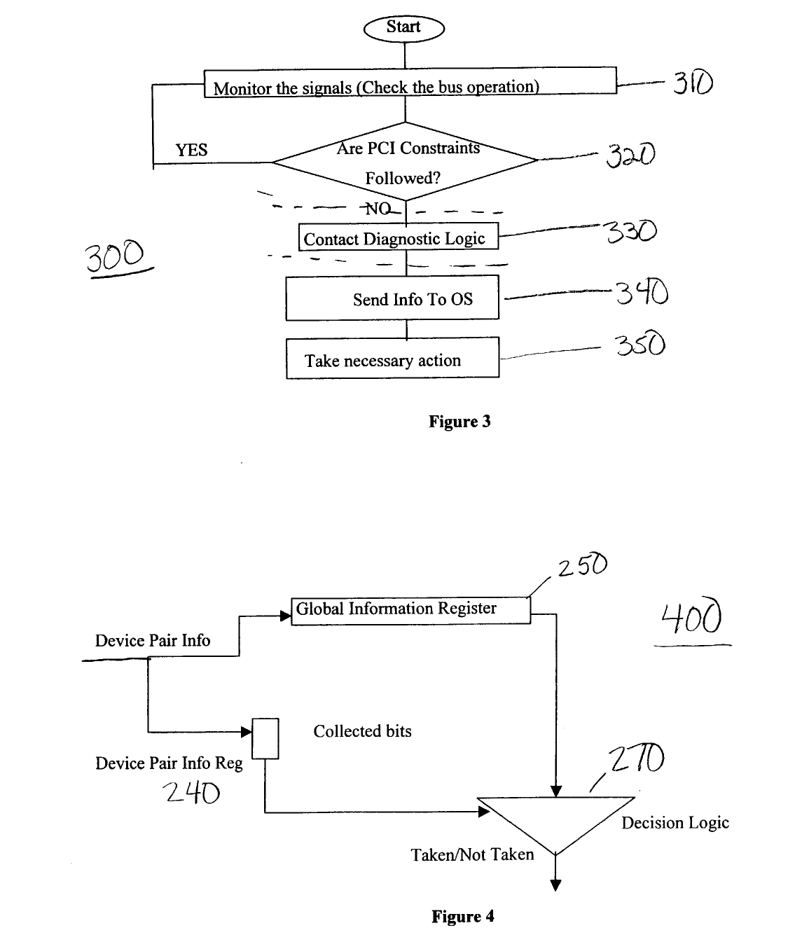

The overall system architecture 200 is shown in FIG. 2 and the process followed by the architecture 200 is shown in the flowchart of the method 300 shown in FIG. 3.

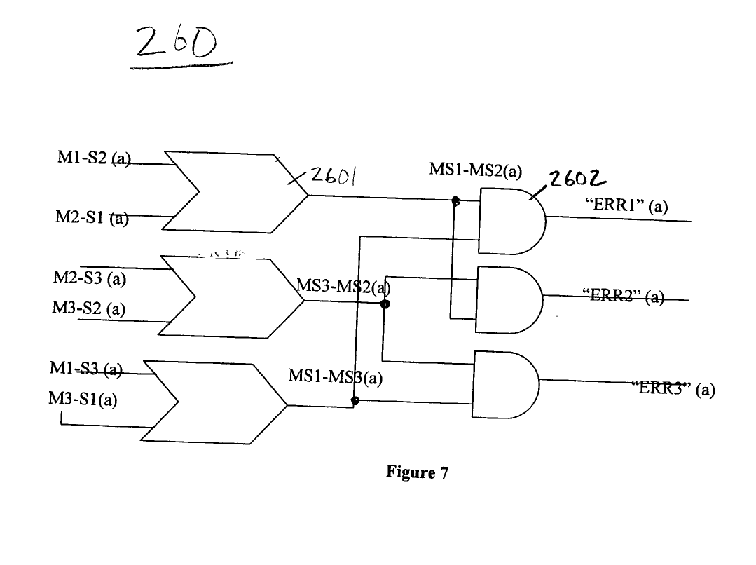

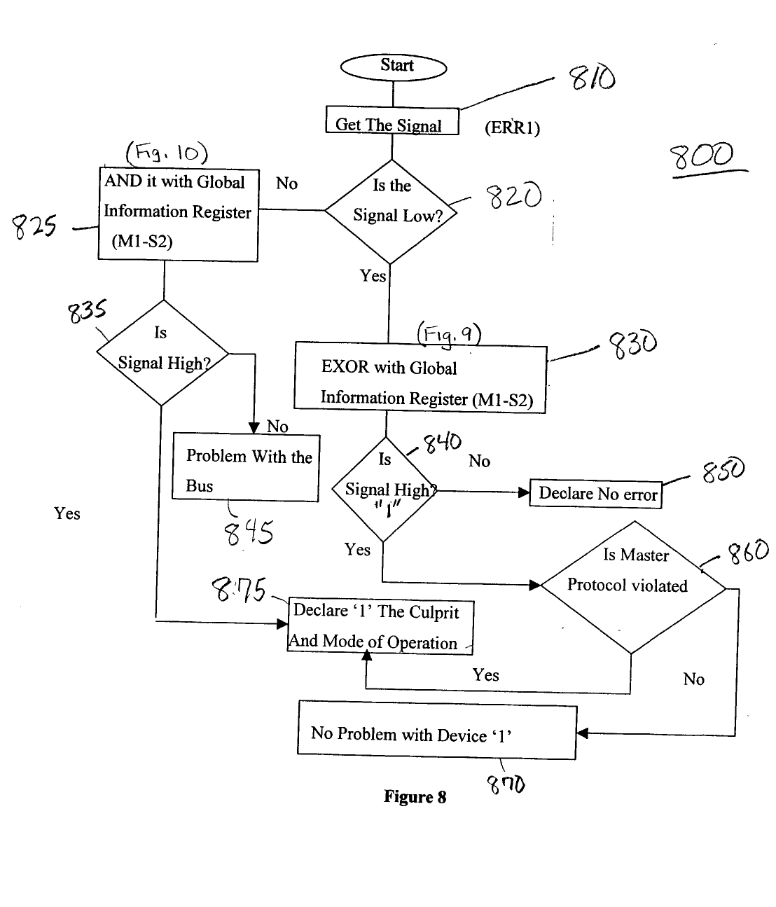

The architecture 200 of FIG. 2 includes a device pair detector 230 (shown in FIG. 5 and discussed in further detail below), a device pair information register 240 (shown in FIG. 5 and discussed in further detail below), an error detector logic 260 (shown in FIG. 7 and discussed in further detail below), and a global information register 250 (shown in FIG. 8 and discussed in further detail below).

In FIG. 2, it is noted that the operating system initializes the system. Further, it is noted that a problem with the PCI bus 140 (having device-pair participants in which one device is a master and another device is the slave) is that one can directly read the master address from the bus 140. However, one cannot read the target address directly from the bus 140.

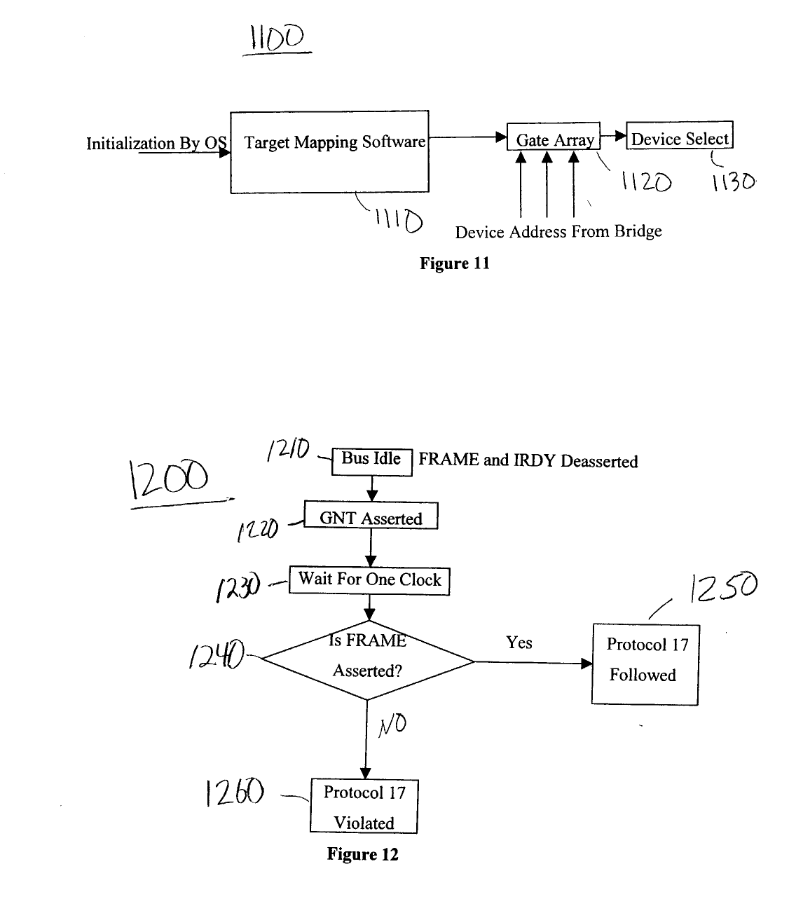

Thus, in FIG. 2, the top left box (e.g., box 210) is provided as a method/means for obtaining the target device information (e.g., software and hardware) (this operation is described in further detail below with reference to FIG. 11). All that the target (e.g., slave device) provides on the bus is the address.

Thus, the address must be mapped to the actual target device (e.g., slave device). Such an operation is performed by box 210, and such cannot be performed without help (e.g., an input) from the operating system. It is noted that the software referred to by “S/W” in box 210 is the target mapping software 1110 shown in FIG. 11, and the hardware referred to by “H/W” is the gate array 1120. Basically, the software must set up the gate array 1120, so that when a device address appears, the gate array 1120 can indicate which device it is. Hence, once the software has been set up, there is no further software involvement here.

Then, the target information is inputted to the device pair detector 230 engaged in the transaction. Also received by the device pair detector 230 is the master address (e.g., received directly from the PCI bus 140).

Then, the device pair detector 230 performs an AND operation (i.e., this is described in further detail below with reference to FIG. 5).

The device pair detector 230 then provides an output to the device pair information register (hardware) 240 and to global information register (H/W-hardware) 250. It is noted that FIG. 5 also illustrates the device pair register 240. That is, the AND network is on the left-hand side of FIG. 5, whereas the right-hand side of FIG. 5 shows the device pair information register 240.

The global information register 250 also receives a VHDL (Very High Speed Integrated Circuit Hardware Description Language) code for determining violation of protocols using a monitor-based approach. For purposes of the present application and as mentioned above, a “monitor-based approach” means the use of an external agent to monitor the operation of a system or subsystem.

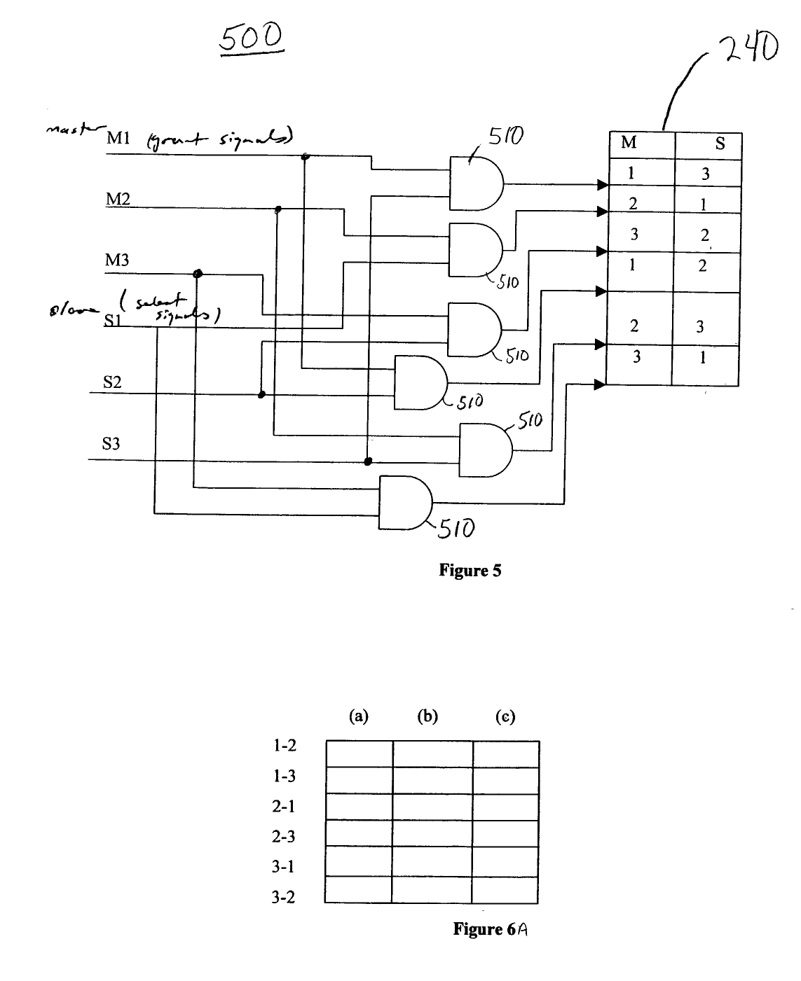

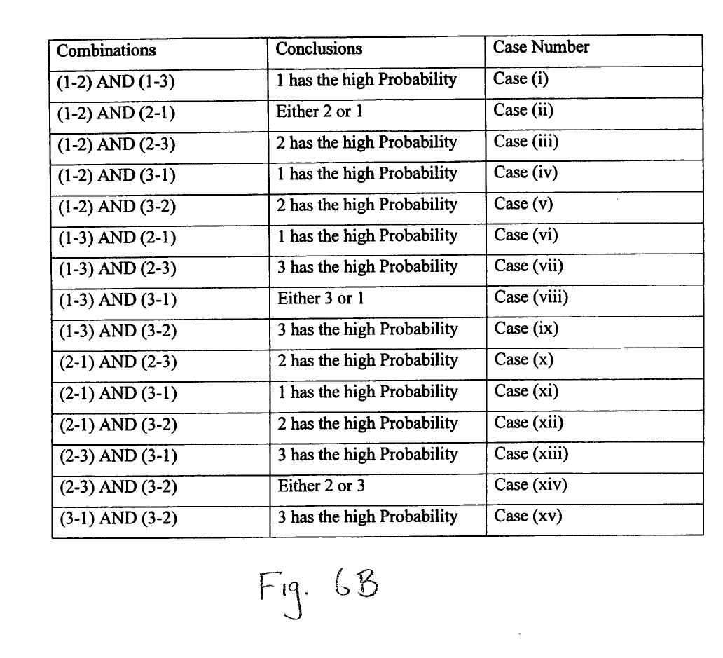

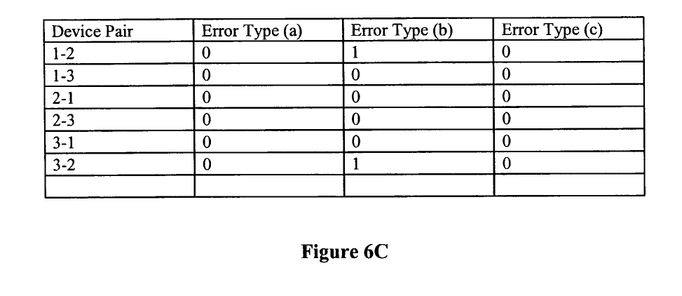

As shown, these signals are input as error signals to register 250. These error signals are shown in FIG. 6A. That is, columns a, b, and c of the register 240 of FIG. 6A illustrate where the error signals feed in. Hence, FIG. 6A shows the possible combinations (e.g., 6) of transactions of three (3) PCI devices 1, 2, and 3 in which the first of these devices is a master and the second device is a slave device. Thus, the left-most column of FIG. 6A designates which device pair is generating an error.

That is, in the first row device 1 is the master and device 2 is the slave, in row 2 device 1 is the master and device 3 is the slave, and so forth. The columns (e.g., a, b, and c) represent the possible errors. The types of errors (e.g., Target Abort, Master Abort, interrupt signals, PERR (e.g., Parity Error), etc.) are described in further detail below.

The device pair detection register 240 will indicate which row is being examined (e.g., which is the master and which is the target/slave). For every one of the errors listed above, a column (e.g., one of a, b, c, d, e, etc.) is provided therefor. Thus, the type of errors will be inserted into the corresponding column. Hence, if an error goes high (e.g., to a “I”), then one knows that that device pair has a problem. Hence, a “1” in column a in the first row might indicate that a Target Abort error occurred in the 1-2 device pair.

Looking at the error signals in greater detail, FIG. 6B shows a table in which various combinations are shown. For row 1 of FIG. 6B for the combination of 1-2 and 1-3, the conclusion is that if an error occurs in both of these device pairs, then since 1 is common to both, then it must be the master which has the error therein. It is noted that, if there is only one transaction, then only one device pair is implicated. If one looks at a group of transactions, then multiple device pairs can be implicated.

Thus, returning now to FIG. 2, the device pair information register 240 receives bus error signals and then provides an input to an error detection logic 260 (described in further detail below with regard to FIG. 7). The error detection logic 260 detects the error based on the device pair information signal, and provides an input to a logic operation device 270.

Logic operation device 270 also receives a global information register signal and performs an AND operation to isolate the faulty device.

Logic operation device 270 then provides an output which represents information about the faulty device.

The Method of the Invention

Turning now to FIG. 3, the method 300 of the present invention will be described.

First, in step 310, bus signals are monitored to check the bus operation.

In step 320, it is determined whether the PCI constraints are being followed or not. If the PCI constraints are being followed (e.g., a “YES” in step 320), then the process returns to step 310.

If the PCI constraints are not being followed (e.g., a “NO”), then the process continues to step 330 at which the diagnostic logic (e.g., 125, 135 in FIG. 1) is contacted, thereby to determine the type of error and to pinpoint the error to the device (e.g., master or target) involved in the transaction. This is a key step in the present invention. That is, by using the constraints and corresponding them to the appropriate type of error (e.g., column in the register), the error type can be identified and subsequently located.

In step 340, the error information is sent to the operating system.

The process concludes in step 350 at which time necessary action is performed to remedy the error. Such necessary action may include presenting an interrupt to the processor, which may then invoke suitable error handling software. For example, the system may be instructed to fail-over to another hardware device, and/or a maintenance call may be requested to replace the malfunctioning device.

Design of Diagnostic Logic 125, 135

In the context of the problem described above, it is very important to design the diagnostic logic 125, 135. As a result, the selection of signals for information plays an important role. The logic is based on an alloyed prediction approach, and is shown in the arrangement 400 of FIG. 4.

FIG. 4 shows device pair information signals being provided from device pair detector 230 to the global information register 250 and to the device pair information register 240 at which bits are collected. The signals from registers 240 (through error detection logic 260) and 250 are provided to the decision logic which corresponds to the logical operation device 270 to determine “Taken” or “Not Taken”.

In FIG. 4, the assumption is that all signals are available and all transactions involve the PCI (bus) bridge. The error signals preferably are captured while a transaction is in process. This will help to locate the master-slave combination-giving rise to maximum number of errors. The approach will help in pinpointing the exact master-slave pair, rather than merely a device. Moreover, it will help to determine which type of operation (e.g., such as a bus read, a bus write, or a status information transfer) causes the maximum number of errors. There are some technical issues regarding this approach, including how to bring a device pair information when the transaction starts since some of the signals will originate from slave, how to know that device is culprit as a master or a slave, and is there some other problem on the PCI bus, such as an infrastructure or timing problem. The present invention addresses each of these issues in an optimal fashion, as discussed below.

FIG. 5 shows the operation of Device Pair Information Register 240.

As shown in FIG. 5, the Device Pair Information Register 240 uses two types of signals for its input (e.g., master and slave). It is well known that the master arbitrates for bus ownership. Arbitrate asserts a grant (GNT) signal to the master authorizing it to drive the bus. A signal called “DEVSEL” is issued by the target, thereby acknowledging that it is ready for the transaction phase.

Assuming that there are three devices 1, 2 and 3 under a monitor agent, it is uncertain which is the master and which is the slave. Here, M1, M2 and M3 are represented as GNT signals and S1, S2 and S3 as DEVSEL signals. The signals are ANDed by AND gates 510 as shown in FIG. 5 to get the information about the device pair involved in transaction.

The information about error signals originating, during a transaction between a master-slave combination, can be stored in the register 240. Thus, as mentioned above, assuming that three error signals a, b and c respectively, are being monitored, the register 240 will appear as shown in FIG. 6A. If an error signal is asserted, then a ‘1’ will be registered, and if not, then a ‘0’ will be registered. Now, considering column (a) of each register, the possible combinations are given in the table of FIG. 6B.

As mentioned above, the error signals for the Device Pair Information Register 240 can be Target Abort (which is generated when TRDY de-asserted, STOP asserted and DEVSEL de-asserted), Master abort, Interrupt signals and PERR, depending upon which signals should be monitored.

Now, it can be observed that Cases (i), (iv), (vi) and (xi) are pseudo-redundant telling only that device ‘1’ is the culprit device. Similarly, Cases (iii), (v), (x) and (xii) give the same information about device 2 and Cases (vii), (ix), (xiii) and (xv) provide the same information for device 3. Thus, any of these cases can be taken. Also, Cases (ii), (vii) and (xiv) do not provide any additional information. Hence, how they can be handled is as shown in FIG. 7.

FIG. 7 shows the error detection logic 260 which, in the exemplary configuration, includes an arrangement of OR gates 2601, each of which receives first and second inputs and provides an output to an AND gate 2602. The AND gate performs an AND operation on the inputs thereto, thereby to output a type of error (e.g., ERR1 (a), etc.) of the bus error signal. It is noted that an erroneous transaction between device pairs 1+2 and 1+3 will generate an error indicated by a “1”, thereby indicating an error with some device pairs having device 1 as a member.

Now, the error must be pinpointed to the master or the target. For this operation, an input from the global information register 250 is employed.

In the global information register 250, the design and addressing scheme will be the same as that for the Device Pair Information Register 240, except that in place of error signals there will be Bus Protocol Signals. If any constraint is violated, then a ‘1’ will be registered for that, otherwise a ‘0’ will be registered. The key here is selection of Protocols. Protocols will correspond to the error signals to be monitored, since it will help to strengthen a conclusion.

A trouble shooting flowchart of a method 800 for determining a specific faulty device (Device ‘1’ in this case) is shown in FIG. 8.

Now, suppose there is no transaction between device 3 and 1, which implies that ‘MS1-MS3’ goes low. Even if ‘MS1-MS2’ is high, ‘ERR1’ will remain low, thereby giving wrong information about the errors. Moreover, if ‘ERR1’ is high, then it is unsure whether it is a master problem or a target problem. Hence, to overcome these limitations, the Global Information Register 250, which preferably has the additional information about the protocols during a transaction between devices, is provided. Thus, once the errors have been identified, now the master or the target must be identified as the culprit by virtue of violation of protocols by devices in the device-pair, and the global information register 250 is used accordingly.

Design and Operation of The Global Information Register 250

The design and addressing scheme of the Global Information Register 250 is similar to that for Device Pair Information Register 240. An exception is that, in place of error signals in register 240, Bus Protocol Signals will be used.

If any constraint is violated, then a ‘1’ will be registered for that violation, otherwise a ‘0’ will be registered. An important aspect is the selection of protocols. Protocols correspond to the error signals to be monitored, since it will help to strengthen the conclusion. Thus, again, given an ambiguity problem, the GIR 250 will help to determine whether the culprit is a master or a target/slave. If it is a bus problem relating to both the master and the slave/target, then the GIR 250 will likewise make such a declaration. The trouble-shooting flow chart for determining a specific faulty device (Device ‘1’ in this case) is provided in the method 800 of FIG. 8.

Specifically, FIG. 8 represents a flowchart of steps which are performed for one device (e.g., Device 1), to test whether Device 1 is the problem/has the error (e.g., is the culprit). Other similar flows would be conducted for other devices connected to the bus, to test whether the problem/error resides with those devices. Thus, if three (3) devices were connected to the bus, then three flows similar to that of FIG. 8 would be performed in parallel.

In method 800, generally the steps on the right-hand side of the flowchart indicate that it is known where the fault resides (e.g., the error is known to exist in a specific one of the target and the master), whereas the left-hand side indicates that the fault is not known to exist in a specific one of the master and the target.

In step 810, a signal is obtained (e.g., “ERR1” from FIG. 7). It is noted that, as shown in FIG. 7, “ERR1” represents an exclusive-OR operation of Master 1-Slave 2 and Master 2-Slave 1). Thus, a “1” will result if an error occurs between a transaction between Master 1-Slave 2 or a transaction between Master 2-Slave 1. By the same token, if the error is on both (e.g., common to) of the transactions, then a “0” will result based on the exclusive OR operation.

Then, it is determined whether the signal is low in step 820. (It is noted that the global information register 250 is primarily interested in the signal having a low level of the bus.)

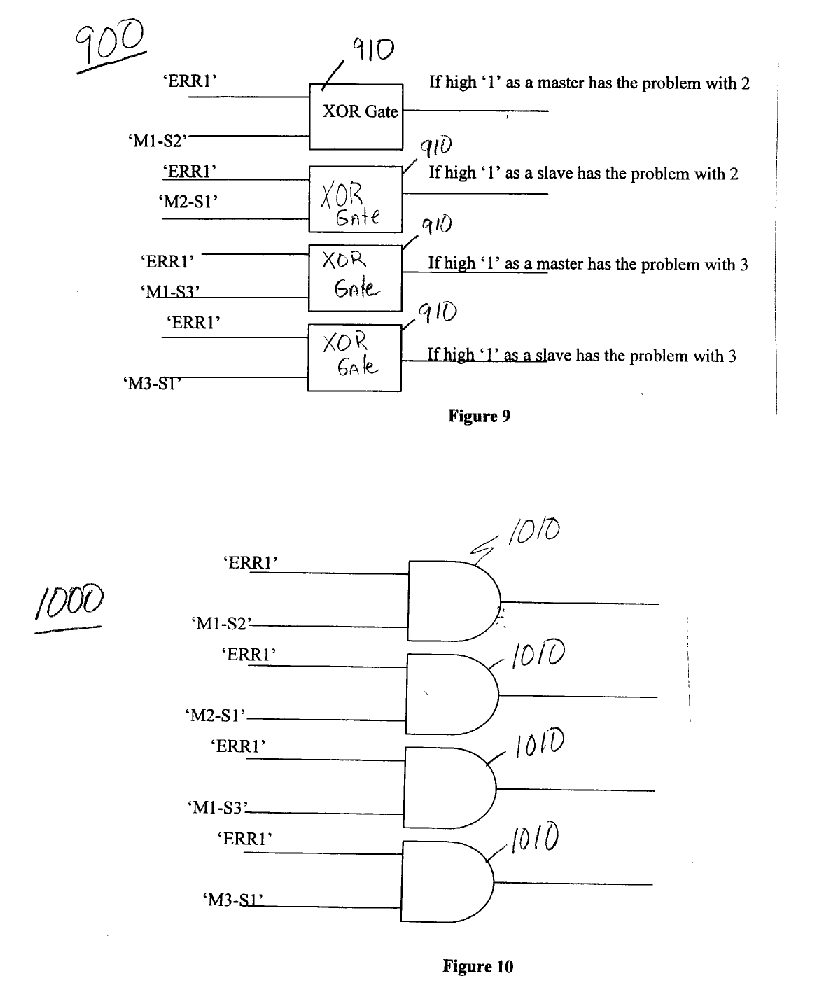

If the signal is low (e.g., a “YES”) (meaning “no fault” and/or knowledge of where specifically the error is), then in step 830, an exclusive-OR operation is performed with the global information register 250 (e.g., M1-S2). It is noted that this step 820 is shown in the top portion of FIG. 9, and is described in further detail below.

That is, an exclusive-OR operation is performed between ERR1 and M1-S2, which is inserted into XOR gate 910 of FIG. 9, thereby to provide an output representing that, if high “1” as a master has the problem with slave 2. That is, the XOR logic only engages when ERR1 is low. Thus, if the output of the XOR is high, then it means that the GIR 250 has detected a protocol violation on a M1-S2 transaction.

As discussed in further detail below, if ERR1 is high (“1”), then it is uncertain whether it is a master problem or a target problem, and step 825 and so forth must be performed to determine the type of problem and what device caused it. Again, if ERR1 is high, then it is unknown whether the error exists in the master or the slave/target, and then an AND operation (via four AND gates 1010 in FIG. 10) is performed with ERR1 and the GIR 250 information, as shown in FIG. 10 and described in further detail below. It is noted that four (4) AND gates are used in FIG. 10, since it is known that there is a problem with device 1, and that then it must be determined in which mode (e.g., master or slave) it was operating and with which other device (e.g., M2, M3, S2, S3) it was performing a transaction.

In step 840, it is determined whether the signal is high (e.g., a “1”). If the signal is high (e.g., “YES”), then the process continues to step 860. If the signal is low (e.g., a “NO”), then in step 850, then no error is declared (meaning no error in the device). Thus, if the signal is low, then there was no transaction involving Device 1 that generated a bus error or a protocol error, either as a Master or as a Slave.

In step 860, it is determined whether the master protocol has been violated. The master protocols are listed and described in further detail below. In the invention, protocols may be master protocols, target protocols, and universal (master-target) protocols. A master protocol indicates that whoever was the master in a transaction was at fault. How one would check whether some exemplary master protocol has been violated would be performed in the exemplary protocol checking methods 1200-1400 of FIGS. 12-14, respectively.

If the master protocol has not been violated, then in step 870 it is determined that there is no problem with device “1”.

By the same token, if it is determined in step 860 that the master protocol has been violated, then the process continues to step 875 at which device 1 is declared as the culprit and likewise its mode of operation (e.g., master or slave) is declared.

Returning now to step 820, if in step 820 it is determined that the signal is not low (e.g., a “NO”), then the process branches to step 825.

In step 825, such information is ANDed with the information from the Global Information Register (M1-S2) 250.

Then, in step 835, it is determined whether the signal is high. If the signal is high, then in step 845 it is determined that there is no problem with the bus. (In other words, if the signal is low, then it is determined that the problem resides with the bus.). In such a case, the devices may be properly operable, but the bus on which they are communicating may have affected the transaction (or if it cannot be determined which device is the culprit).

If the signal is determined to be high in step 835, then in step 875, Device “1′ is declared as the culprit and the mode of operation (e.g., device 1 is a master or device 1 is a slave). At that time, the operating system may take corrective action. Again, the “mode of operation” being declared means that the device is acting as a master or that the device is acting as a slave is also declared.

It is clear from method 800 of FIG. 8 that there is a need for registering PCI protocol signals in an order. Thus, suppose that there are ‘p’ PCI protocol signals in which ‘m’ are masters, ‘n’ are targets, and ‘i’ are both master and slave protocols. As such, GIR 250 will have initial ‘m’ cells dedicated to master protocols, next ‘n’ to target protocols and so on. Hence, in case of a decision operation ‘Is master protocol violated?’, one can go back and check the register 250. If any of ‘m’ initial bits are high, then it is a master protocol violation.

Hereinbelow is described is how to make the decision. This can be done with the help of a multiplexer. Next will be described is how to perform XOR and its operation, its significance and so forth. This is shown in FIG. 9.

Thus, returning to FIG. 9, even if the device pair information register 240 gives the wrong result, one can still make the prediction based on Global information in the GIR 250. If, after the XOR operation, the signal goes high, it does not provide complete information about the faulty device, but it does indicate the mode of operation. If the GIR 250 is checked to see what protocols are broken, then one can conclude about the faulty device and its mode of operation.

As shown in FIG. 9, if both signals are high, then one can predict about the faulty device and its mode of operation.

Hereinbelow is described in further detail how to fix the above errors in the device pairs, and pinpoint the faulty device.

Capturing Address of Target Device On PCI Bus (Tapping DEVSEL Signal)

Hereinbelow is described how to obtain the device address. Regarding the master, information can be obtained from the bus arbiter residing on the PCI Bridge 140. The master device address can be obtained as soon as the GNT is asserted.

The next issue is how to obtain a Target Signal (DEVSEL) since it is a bus signal. This is accomplished as follows.

Every time a system boots up, the operating (OS) performs the address initialization of the devices. Hence, the OS reserves the address space for devices, and the information remains in a device driver of each device. A field programmable gate array (FPGA)) or some other logic assemblage can be designed, in which the code will be activated by target mapping software as the OS and will write the device addresses into the Gate Array. The device (target) address can be obtained from the PCI bus bridge, and hence the information about the Target Device can obtained. As alluded to above, this approach can be understood as shown in the structure 1100 of FIG. 11, including target mapping software 1110 and gate array 1120. It is noted that the device select 1130 is the same as the device pair detection 240 (for obtaining the target address information).

List of Possible PCI Protocols

Regarding the possible PCI Protocols, hereinbelow is provided some of the exemplary protocols.

I. Bus should be idle or return to idle (FRAME and IRDY deasserted)

II. TRDY (target ready) cannot be driven until DEVSEL (device select) is asserted.

III. Only when IRDY is asserted can FRAME be deasserted indicating a last data phase.

IV. Transaction need not be terminated after timer expiration unless GNT is deasserted.

V. Once FRAME has been deasserted, it cannot be reasserted during the same transaction.

VI. Once a master has asserted IRDY, it cannot change the IRDY or FRAME until the current data phase completes.

VII. Master must deassert IRDY after the completion of the last data phase.

VIII. STOP cannot be asserted during a turn-around cycle between the address phase and a first data phase of read transaction.

IX. Data phase completes on any rising edge on which IRDY is asserted and either STOP or TRDY is asserted.

X. Independent of the state of STOP, a data transfer takes place when IRDY and TRDY are asserted.

XI. Once STOP is asserted, the target must keep it asserted until FRAME is deasserted, where upon the target must deassert STOP.

XII. Once TRDY or STOP is asserted target cannot change DEVSEL, TRDY or STOP until data phase completes.

XIII. STOP is asserted, master must deassert as soon as IRDY can be deasserted.

XIV. TRDY, STOP and DEVSEL must be deasserted following the completion of the last data phase.

XV. If GNT is deasserted and FRAME is asserted, then the bus transaction is valid and will continue.

XVI. While frame is deasserted, GNT may be deasserted at any time in order to service a higher priority master.

XVII. Master must assert FRAME at the first clock possible when FRAME and IRDY are deasserted and its GNT is asserted.

XVIII. When target terminates transaction by STOP, the master must deassert its REQ for a minimum of two clocks.

XIX. A target must qualily IDSEL with FRAME and before DEVSEL can be asserted on a configuration command.

XX. Special Cycle command:—No target respond.

The protocols are classified as “universal protocols” meaning that they help to determine the violation of other protocols and making a decision.

For example, protocol ‘1’ is a universal protocol, since the bus will go idle after the end of every data transaction. Similarly, protocols 2, 3, 7, 9, 14 and 17 are universal protocols.

Hereinbelow are described flowcharts for how these protocols can be implemented in methods 1200, 1300, and 1400 in FIGS. 12-14. Several protocols are illustrated below. All other protocols can be implemented as shown in FIGS. 12-14. The protocols can be classified as “master protocols” (1, 3, 5, 6, 7, 13 and 17), “target protocols” (2, 8, 12, 14, 19), and “master-target protocols” (11 and 18).

Turning to FIG. 12, a flowchart of a method 1200 is shown for processing the above-mentioned protocol 17 (e.g., “Master must assert FRAME at the first clock possible when FRAME and IRDY are deasserted and its GNT (grant) is asserted.”), to determine if protocol 17 is being followed or violated. In Protocol 17, IRDY means I/O ready.

In step 1210, the bus is idle, and FRAME and IRDY have been deasserted.

In step 1220, GNT (grant) is asserted, and in step 1230 the system waits for one clock period. This waiting is to meet certain bus timing requirements according to the PCI Bus standard specification.

In step 1240, it is determined whether the FRAME is being asserted (e.g., asserted by the master). If FRAME is being asserted (e.g., a “YES”), then it is determined in step 1250 that protocol 17 is being followed.

If FRAME is not being asserted (e.g., a “NO” in step 1240), then it is determined that protocol 17 is being violated by the master.

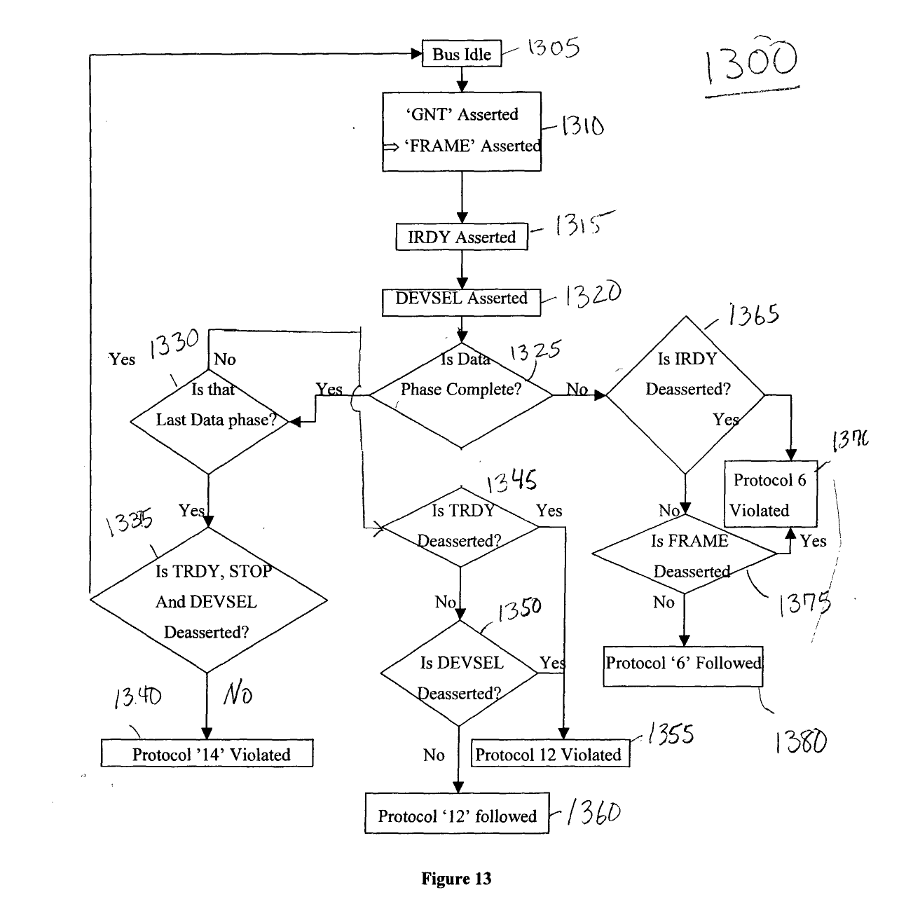

FIG. 13 shows a method 1300 of checking other protocols (e.g., protocols 6, 12, 14) being followed or violated. Protocols 12 and 14 are target protocols, whereas protocol 6 is a master protocol. Thus, FIG. 13 shows how double violations might be detected. These checks are performed in parallel in the method 1300.

In step 1305, the bus is idle.

In step 1310, GNT is asserted and FRAME is asserted.

In step 1315, IRDY is asserted, and in step 1320, DEVSEL is asserted.

In step 1325, it is determined whether the data phase is completed. If “YES”, then the process continues to step 1330 where it is determined whether the completed data phase is the last data phase. If “NO”, then the process loops back to step 1325.

If “YES” in step 1330 (e.g., the completed data phase is the last data phase), then in step 1335, it is determined whether TRDY, STOP, and DEVSEL are deasserted. If TRDY, STOP, and DEVSEL are deasserted (e.g., a “YES”), then the process loops back to step 1305.

By the same token, if TRDY, STOP, and DEVSEL are not being deasserted (e.g., a “NO”), then it is determined that protocol 14 was violated.

Further, regarding step 1325, it is noted that if the data phase is complete, but this is not the last data phase (e.g., a “NO”, in step 1330), then a check for violation of protocol 12 is made.

Thus, if in step 1325, it is determined that the data phase is complete (but is not the last phase as determined by step 1330), then the process continues to step 1345 where it is determined whether TRDY is deasserted.

If “YES” in step 1345, then protocol 12 is determined to have been violated. If “NO”, then in step 1350, it is determined whether DEVSEL is deasserted. If “YES”, then protocol 12 is being violated.

If “NO” in step 1345, then it is determined that protocol 12 is being followed.

If, in step 1325, it is determined that the data phase is not complete, then in step 1365 it is determined whether IRDY is deasserted. If “YES” in step 1365, then in step 1370 it is concluded that protocol 6 is violated.

If “NO” in step 1365, then in step 1375, it is determined whether FRAME is deasserted. If FRAME is deasserted (e.g., a “YES” in step 1375)), then in step 1370 it is concluded that protocol 6 is violated.

If a “NO” occurs in step 1375 (e.g., FRAME is not deasserted), then it is determined that protocol 6 is being followed in step 1380.

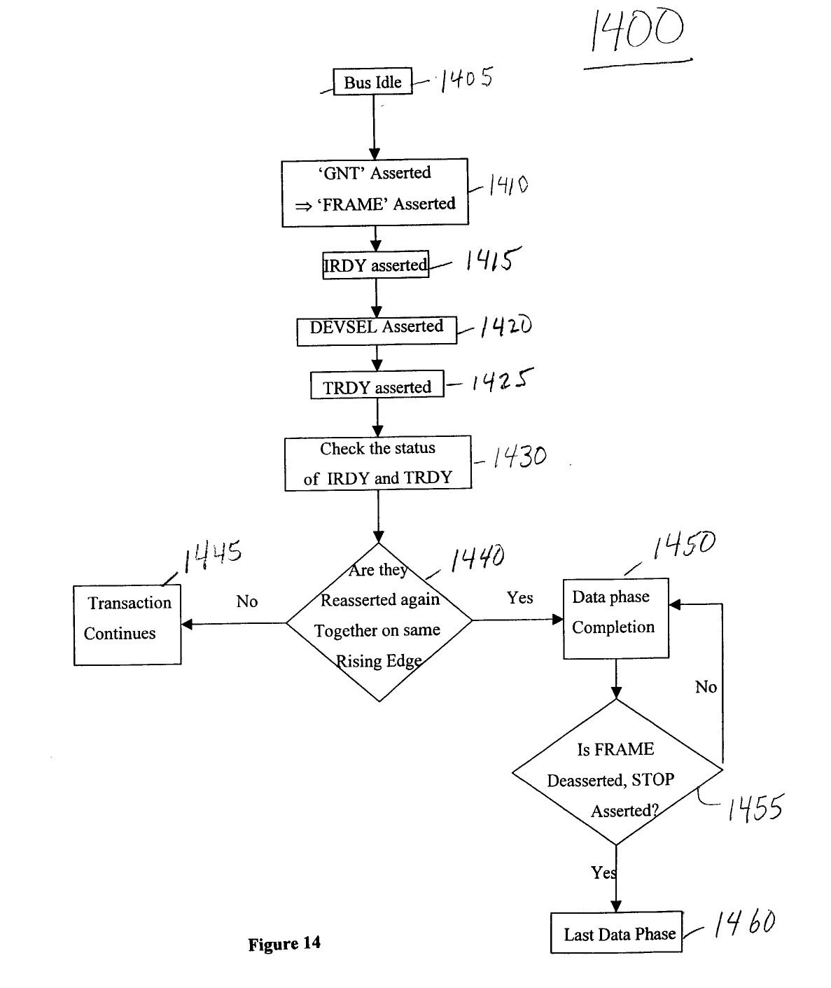

FIG. 14 illustrates a method 1400 which is a sub-routine of use with the method of FIG. 13, and which determines whether the data phase is complete (e.g., step 1325 of FIG. 13) in a specific transaction in which master and target are communicating with each other and data is being sent over a bus. Thus, FIG. 14 does not represent a protocol check, but instead is a subroutine which determines whether the data phase is complete (e.g., step 1325 of FIG. 13). That is, this sub-routine determines whether the data has been sent completely and would be useful with the flowchart of method 1300 in FIG. 13.

More specifically, it is recognized that the bus may “stutter”, and as such a transaction does not have a beginning and an end with nothing in between, but instead may have a beginning and then stop, and then continue. Thus, it is useful to have a way of determining when a given transaction is completed. As a result, the method 1400 of FIG. 14 is provided, and could be inserted at step 1325 of FIG. 13.

Turning now to the method 1400 of FIG. 14, in step 1405, the bus idle and in step 1410 GNT is asserted and FRAME is asserted. Thereafter, in step 1415, IRDY is asserted.

In step 1420, DEVSEL is asserted, and in step 1425, TRDY is asserted.

In step 1430, the status of IRDY and TRDY is checked.

In step 1440, it is determined whether they (IRDY and TRDY) are reasserted again together on the same rising edge of a bus signal. If “NO” in step 1440, then in step 1445 the transaction continues.

If “YES” in step 1440 (e.g., the IRDY and TRDY are being reasserted again together on the same rising edge of a bus signal), then in step 1450 the data phase is completed, and in step 1455 it is determined whether the FRAME is deasserted and the STOP is asserted.

If “NO”, then the process loops back to step 1450. If “YES”, then in step 1460 it is concluded to be the last data phase (this corresponds to the decision block 1330 in FIG. 13).

It is noted that, while the above-described methods have been directed to making a diagnosis based on only one transaction (e.g., in which only one row in FIG. 6A could possibly be populated), the diagnosis can be based on several transactions, in which case several rows in FIG. 6A might contain entries.

For example, FIG. 6C shows the contents of the error register after several transactions have occurred. It is recalled that a ‘0’ in a cell indicates that there was no error of the type indicated in the first row of that column for the device pair named in the first column of that row, and a ‘1’ in a cell indicates that such an error was observed for such device pair. In all of these transactions, suppose Device 2 is faulty, but only for error type b, and only when it is a slave. Assuming that the transactions that have been monitored include a transaction where 1 is the master and 2 is the slave, and one where 3 is the master and 2 is the slave, then the table would appear as shown in FIG. 6C.

From positions of the ‘1’s in the table of FIG. 6C, it is possible to determine that device 2 is in error, when it is acting in a slave capacity. In accordance with this technique, observation of multiple transactions between all the participants on the bus allows determining which device of a device pair is faulty.

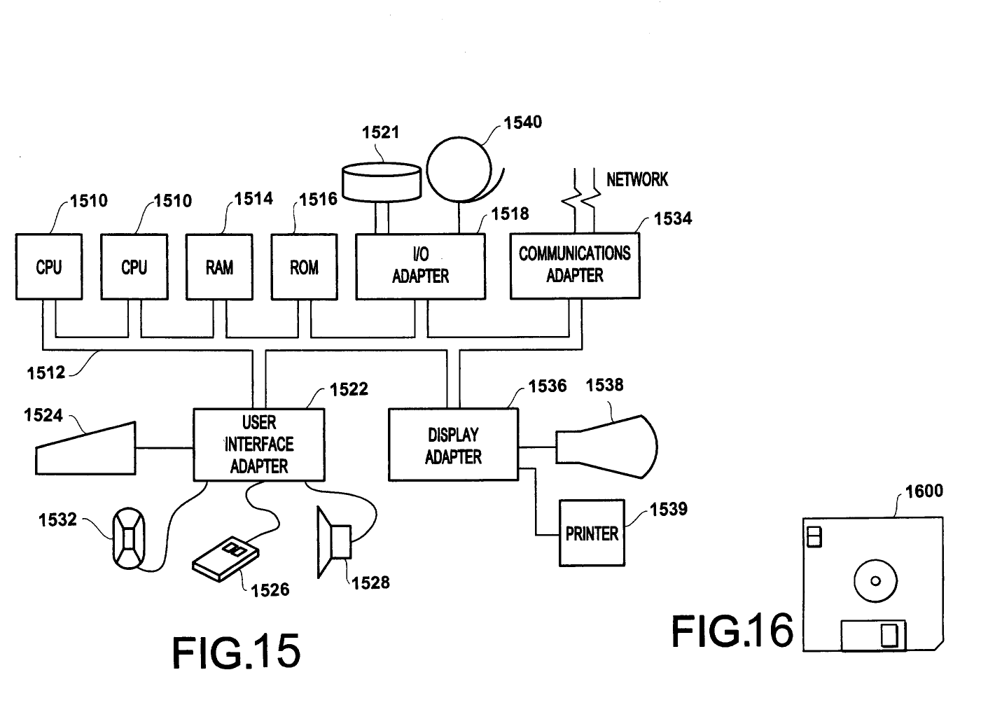

FIG. 15 illustrates a typical hardware configuration of an information handling/computer system for use with the invention and which preferably has at least one processor or central processing unit (CPU) 1511.

The CPUs 1511 are interconnected via a system bus 1512 to a random access memory (RAM) 1514, read-only memory (ROM) 1516, input/output (I/O) adapter 1518 (for connecting peripheral devices such as disk units 1521 and tape drives 1540 to the bus 1512), user interface adapter 1522 (for connecting a keyboard 1524, mouse 1526, speaker 1528, microphone 1532, and/or other user interface device to the bus 1512), a communication adapter 1534 for connecting an information handling system to a data processing network, the Internet, an Intranet, a personal area network (PAN), etc., and a display adapter 1536 for connecting the bus 1512 to a display device 1538 and/or printer.

In addition to the hardware/software environment described above, a different aspect of the invention includes computer-implemented methods for performing the above-mentioned methods. As an example, these methods may be implemented in the particular environment discussed above.

Such methods may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 1511, as represented by the fast-access storage for example. Alternatively, the instructions may be contained in another signal-bearing media, such as a magnetic data storage diskette 1600 (FIG. 16), directly or indirectly accessible by the CPU 1511.

Whether contained in the diskette 1600, the computer/CPU 1511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

With the unique and unobvious features of the present invention, of the present invention, a culprit device can be pinpointed using Boolean logic based on alloyed prediction rather than weights based on misprediction. Additionally, no history tables or a pattern history table are required by the invention, thereby resulting in reduced hardware. Additionally, the OS can take any necessary actions based on seriousness of fault.

Hence, the present invention provides a monitor-based approach which is based on the PCI bus specification and is used to detect whether the PCI Bus constraints are obeyed. The monitor is developed preferably using Hardware Descriptive Languages (HDL) to describe appropriate behavior, and is implemented preferably using environments, or agents. These agents satisfy separability rules, which means that the output of each agent is different from the output of the other agent.

While the invention has been described in terms of several preferred embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of monitoring a bus with pair-wise participants, comprising:
detecting a problem during a transaction between first and second participants on said bus; and
determining which participant is at fault for said problem or whether said problem comprises a systemic bus problem.

2. The method of claim 1, wherein said determining is based on observing a plurality of transactions and detecting said problem.

3. A method of fault isolation at a device level on a bus, comprising:
based on the hardware bus specification, detecting, with a monitor, whether the hardware bus constraints are obeyed,
wherein the monitor is developed using Hardware Descriptive Languages (HDL) to describe behavior, and is implemented using environments.

4. The method of claim 3, wherein said environments comprise agents.

5. The method of claim 3, wherein if constraints under an agent's control are followed, then the agent generates a correct signal, and if said agent generates a signal that is false then the hardware bus constraints have been violated.

6. A method of isolating fault in a system, said system having device pairs on a bus, comprising:
judging whether a fault has occurred;
determining if one of the devices of a device pair caused the fault; and
if said one of the devices is determined not to have caused the fault, identifying the cause of the fault as a bus fault.

7. The method of claim 6, wherein said bus comprises a peripheral component interconnect (PCI) bus.

8. The method of claim 6, wherein said devices comprise PCI devices.

9. A system for isolating fault at a device level on a bus, comprising:
a device pair detector for receiving a master address information and a target address information;
a device pair information register for receiving an output from said device pair detector;
an error detection logic for receiving an output from said device pair;
a global information register for receiving an output from said device pair detector and a protocol violation checking logic; and
a logical operation unit for determining which, if any, of said target and said master is a cause of said fault based on outputs from said error detection logic and from said global information register,
wherein if said logical operation unit identifies neither of said target and said master as the cause, then said logical operation unit determines that the cause comprises a systemic bus problem.

10. The system of claim 9, further comprising a unit for obtaining the target device information.

11. The system of claim 10, wherein said unit comprises a target mapping module and a digital logic, wherein an operating system sets up the digital logic, such that when a device address appears, the digital logic provides an output indicating an identity of said device.

12. The system of claim 11, wherein the target information is inputted to the device pair detector engaged in the transaction, and the device pair detector receives the master address directly from the bus,
wherein said device pair detector performs an AND operation to provide said output to said global information register and said device pair information register.

13. The system of claim 9, wherein the global information register is implemented by a Very High Speed Integrated Circuitry Hardware Development Language (VHDL) code for determining violation of protocols using a monitor-based approach.

14. The system of claim 13, wherein said VHDL code comprises at least one error signal,
said at least one error signal comprising a Target Abort, a Master Abort, an interrupt signal, and a parity error (PERR) signal.

15. The system of claim 9, wherein said global information register receives bus protocol signals, said protocols corresponding to the error signals to be monitored.

16. A method of fault isolation in a bus including at least first and second participants selectively involved in a transaction, comprising:
monitoring bus signals to check the bus operation;
determining whether bus constraints are being followed; and
if the bus constraints are not being followed, contacting diagnostic logic, thereby to determine a type of error and to pinpoint the error to one of the first and second participants involved in the transaction.

17. The method of claim 16, wherein said contacting comprises using the constraints and corresponding them to a type of error such that the error type can be identified and subsequently located.

18. The method of claim 16, further comprising:
sending error information to an operating system.

19. The method of claim 18, further comprising:
performing action to remedy the error.

20. The method of claim 16, wherein all transactions involve the bus, and error signals are captured while a transaction is in process.

21. A method of trouble-shooting for determining a specific faulty device on a bus, comprising:
obtaining an error signal indicating an error in a transaction involving first and second participants in the transaction;
determining whether the signal has a predetermined value; and
if the signal has the predetermined value, performing a logic operation with a global information register, thereby to indicate which of said two participants has the problem.

22. The method of claim 21, wherein said logic operation comprises an exclusive-OR operation.

23. The method of claim 21, further comprising:
if said error signal has a second predetermined value, then judging that it is uncertain whether it is a master problem or a target problem; and
determining a type of problem and what participant caused said problem, said determining comprising performing a second logic operation with said error signal and the global information register information, to obtain a signal having a predetermined value,
wherein if said signal has a first predetermined value, then the problem is identified as a bus problem, and if said signal has a second predetermined value, then the participant causing the problem and its mode of operation are determined.

24. The method of claim 23, wherein said second logic operation comprises an AND operation, and wherein said first predetermined value is low and said second predetermined value is high relative to said first predetermined value.

25. The method of claim 22, further comprising:
determining whether the signal has a predetermined value which is high; and
if the signal has a predetermined value which is low, then declaring no error.

26. The method of claim 25, further comprising:
if the signal is high, then determining whether the master protocol has been violated, wherein said master protocol indicates that whoever was a master in the transaction was at fault;
if the master protocol has not been violated, then determining that there is no problem with the device; and
if it is determined that the master protocol has been violated, then declaring the device as the cause of the problem and declaring its mode of operation.

27. The method of claim 22, wherein the predetermined value indicates “no fault” and/or knowledge of where specifically the error is.

28. The method of claim 21, wherein said method is performed in parallel for each device coupled to the bus.

29. The system of claim 9, wherein said error detection logic comprises a plurality of exclusive OR gates.

30. A signal bearing medium tangibly embodying a program of machine-readable instructions executable by a digital processing apparatus to perform a method of monitoring a bus with pair-wise participants, comprising:
detecting a problem during a transaction between first and second participants on said bus; and
determining which participant is at fault for said problem or whether said problem comprises a systemic bus problem.

31. A system for monitoring a bus with pair-wise participants, comprising:
a detector for detecting a problem during a transaction between first and second participants on said bus; and
a determining unit for determining which participant is at fault for said problem or whether said problem comprises a systemic bus problem.
